(19) United States
(12) Patent Application Publication
(10) Pub. No.: US 2021/0219529 A1
(43) Pub. Date: Jul. 22, 2021

(54) Magnetic Braking System

(71) Applicant: Jeffrey Byrne, Scotland (CA)

(72) Inventor: Jeffrey Byrne, Scotland (CA)

(21) Appl. No.: 16/748,444

(22) Filed: Jan. 21, 2020

(51) Int. Cl. A01K 89/0155

(52) U.S. Cl. CPC A01K 89/01555

(57) ABSTRACT

In some embodiments, the system for magnetic braking in fishing reels includes a fishing reel including a spool, a lever, a rotor, and a movable slider device. The rotor includes a plurality of spaced-apart holes and a plurality of magnets in the plurality of holes. The slider device includes a first sheet, a second sheet and a third sheet. Each of the second sheet and the third sheet include a magnet in a hole. The slider device is movable between a first position and a second position, where the first position is farther apart from a center of the rotor. The interactions between the one or more magnets of the movable slider device and the plurality of the magnets of the rotor cause the rotor to brake when the movable slider device is at the second position.

### REFERENCE TO PENDING APPLICATIONS

This application does not claim benefit of any issued U.S. patent or pending applications.

### BACKGROUND OF THE INVENTION

### Field of the Invention

The present invention relates generally to a braking system, and in particular to a magnetic braking system.

### Background

In a traditional braking of a line spool of a fishing reel during casting, the line spool usually rotates at a speed higher than the reeling-out speed of the line, which can result in backlash and overturning of the spool with ensuing line entanglement. Therefore, there is a need to improve braking in fishing reels to minimize or even eliminate this problem.

U.S. Pat. No. 4,593,866A discloses a fishing reel comprising a frame, a line spool rotatably and releasably mounted in the frame and an induction-type magnetic brake for braking the fishing reel during casting is disclosed, in which a number of permanent magnets are mounted on a support which is easily releasably fixed to one end of the frame and encloses an opening therein, and in which the pole support is easily removable together with the magnet poles as a unit for uncovering said opening, and said opening is of a sufficient dimension to permit withdrawal of the line spool through the uncovered opening. In the preferred embodiment, the magnet support also forms a support for one end of a spindle which supports the line spool in the reel frame. The fishing reel fragmentarily comprises a magnetic brake according to the invention which comprises an annular magnet support generally designated and detachably mounted in a circular hollow space which is provided in one end wall of the frame of the fishing reel and which is open towards one end wall of a rotatable line spool. Disposed in the annular support is an annular plate which constitutes a planar bottom plate for a number of small cylindrical permanent magnets. An adjusting knob which is mounted on the threaded portion of a bolt, has an inner flange engaging a planar supporting surface of the outer end wall. By turning the knob in one direction, the magnet support 1 can be moved in a direction away from the end wall of the line spool, and by turning the knob in the opposite direction, the support is returned by the spring towards the line spool. In this manner, a gap between the ends of permanent magnets and the spool end wall, and thus the magnetic force, can be varied.

U.S. Pat. No. 7,938,353B2 discloses a brake system for a fishing reel. The brake system includes a spool cover which is provided between a spool and a left cover, and a brake assembly which is provided between the spool and the spool cover. The spool cover has a cylindrical inner sidewall, a first brake collar which is provided on the inner surface of the sidewall, a circular protrusion which is provided on the central portion of the spool cover, and a second brake collar or one way ring which is provided on the circular protrusion. The brake assembly includes a brake housing, brake shoes, expansion springs, and a housing cover. The brake housing has inner seating depressions and outer seating depressions therein. The brake shoes are inserted into the inner seating depressions. The expansion springs are inserted into the inner seating depressions to elastically support the brake shoes. The housing cover is coupled to the outer surface of the brake housing to prevent the brake shoes and the expansion springs from being removed from the brake housing. A magnetic brake is mounted to an inner surface of a spool cover. A brake assembly is made of appropriate such that a magnetic body of the magnetic brake can affect it.

U.S. Pat. No. 2,953,314A discloses a system to provide a level wind fishing reel having automatic magnetic brake means for exerting a drag upon the level wind mechanism to prevent back lash during casting. A magnetized element is pivotally supported at its uppermost end by means of a pivot pin to the upper portion of the bracket. A longitudinal friction member fixed to the feed bar is disposed intermediate the opposite free end of the magnetized element and the drum. This friction member is also of a magnetic material so as to attract the free end of the magnetized element and normally prevent relative longitudinal movement therebetween. The free end of the fishing line extends through a longitudinal slot adjacent to a free end of the magnetized element for guiding action by the level wind bracket and for controlling the position of the magnetized element.

U.S. Pat. No. 5,273,235A discloses a fishing reel includes a spool for taking up a fishing line and acting as an electric conductor also, and a brake mechanism having permanent magnets arranged adjacent a side face of the spool. The brake mechanism includes a controller for controlling a distance between the magnets and spool, and a perforated shield plate formed of a magnetic substance for insertion between the magnets and spool. The shield plate is interlocked to the controller such that magnetic flux of the magnets is shielded in a progressively increasing amount as the controller is operated in a direction to increase the distance between the magnets and spool. Where the above features are arranged for example, a controller is operated to reduce the distance between permanent magnets and electric conductor (rotary element itself acts as the conductor) to increase magnetic flux of the magnets applied to the conductor, thereby increasing the braking force. For reducing the braking force, the controller is operated to increase the distance between permanent magnets and electric conductor and also to insert a shield plate between the permanent magnets and electric conductor. The shield plate intercepts the magnetic flux, thereby to substantially reduce the magnetic flux acting on the conductor.

U.S. Pat. No. 2,482,428A discloses a This invention relates to a fishing reel and more particularly to an improved type of reel having a compensated magnetic brake means for preventing backlash or overrunning of the spool. The effect of the magnets on the discs when the spool is rotating at its normal speed of approximately revolutions per minute, is such that the discs are repelled by the magnets and the distance between the discs increases and the braking effect decreases. As the speed of the spool increases, the effect of the tension of the spring in causing engagement of the brake becomes less and as the speed of the spool decreases the spring then acts as ‘a governor as the momentum of the spool dies down. When the spool is not in motion the discs acting through the felt washers frictionally hold the spool ill with a force strong enough to start a hard cast without the necessity for applying thumb pressure to the spool at the beginning of the cast as is commonly required in other types of reels. described arrangement the spring in combination with the cam elements automatically modify the brake action resulting from the magnetic action.

US20160037759A1 discloses a spool braking device, that brakes the rotation of a spool rotatably supported by a reel body. The spool, which is a conductor that is rotated in conjunction with the spool. The magnet includes an N-pole and an S-pole on a surface that faces the rotating surface of the spool. The retaining member, the support ring, and the engagement member form a magnetic flux change rate variable mechanism. The magnetic flux change rate variable mechanism varies the change rate of the flux in the rotational circumferential direction that is affected by the magnet, at a prescribed rotating surface of the spool having a prescribed unit width in the rotational axis direction, with the rotation of the spool. The spool braking device comprises a tubular portion, a magnet, a retaining member, a support ring, and an engagement member. The tubular portion is disposed so that the center axis thereof aligns with the center axis of the spool shaft.

U.S. Pat. No. 9,635,843B2 discloses a spool braking device includes a conductor, a magnetic unit, and a support portion. The conductor has a rotational surface and is configured to rotate in conjunction with a spool rotatably supported by a reel body. The magnetic unit has at least two magnets arranged on a surface facing the rotational surface of the conductor. The support portion movably supports the magnetic unit between a separated position that is separated from the rotational surface of the conductor and a proximal position that is proximate to the rotational surface of the conductor. The biasing member is configured to bias the magnetic unit from the proximal position to the separated position.

U.S. Pat. No. 7,717,366B2 discloses an adjustable fishing reel spool brake, the reel having a body, comprising in combination, the spool having a lic zone that rotates as the spool rotates, a magnetic flux provider carried on the reel body, the provider adjustably movable to vary magnetic flux establishment in the path of rotation of said zone and acting to resist and thereby brake reel rotation.

U.S. Pat. No. 4,561,605A a fishing reel is provided with a spool and a magnetic brake for reducing overrun of the spool. The spool has a frame member which rotatably supports the spool, a cylindrical electric conductor rotatable together with the spool, and a magnet holder having at least one magnet positioned at one side of the holder radially of the conductor and opposite thereto. The holder has a support unit which supports the holder to the frame member so that the magnet can be adjusted radially toward or away from the conductor to thereby adjust the braking of the conductor. The support means includes a control member which controls the holder to move toward the position where the magnet is adjusted.

U.S. Pat. No. 6,086,005A discloses a fishing reel is provided which is capable of preventing noise and rapid change in the rotational speed of the spool which take place when a casting operation is performed, controlling backlash of a fishing line by a person even if the person is not skilled in the casting operation and maintaining the distance for which the tackle can be thrown. The fishing reel having a reel body having a clutch-equipped rotational-force transmission means for selecting a spool free state in which the free rotation of the spool is permitted and unreeling of the fishing line is permitted and or spool operation state in which the spool is rotated and the spool winds the fishing line; a conductive member provided for the spool; magnets for supplying magnetic force to the conductive member provided for the reel body to brake the rotation of the spool; and a spool rotational-speed control means for enlarging/reducing the magnetic force of the magnets which acts on the conductive member in accordance with the rotational speed of the spool so as to control the rotational speed of the spool. The plural magnets are provided for the side wall of the reel body through a magnetic-force adjustment means for adjusting the magnetic force of the magnets which acts on the stationary conductive member.

### BRIEF SUMMARY OF THE INVENTION

In some embodiments, a system for magnetic braking is disclosed. In some embodiments, the system for magnetic braking in fishing reels includes a fishing reel including a spool, a lever, a rotor, and a slider device. The rotor includes a plurality of spaced-apart holes located at substantially a same distance from each other in a circular manner on the rotor, and a plurality of magnets located in the plurality of holes. A first end of each of the plurality of magnets is positioned in a common plane perpendicular to an axis of rotation of the spool. The slider device includes a first sheet, a second sheet over the first sheet and a third sheet over the second sheet. Each of the second sheet and the third sheet include a magnet in a hole. The slider device is movable between a first position and a second position, where the first position is farther apart from a center of the rotor. The interactions between the one or more magnets of the movable slider device and the plurality of the magnets of the rotor cause the rotor to brake when the movable slider device is at the second position.

In some embodiments, the rotor and the slider device are configured to brake the fishing reel once they are engaged. To that end, the slider device is so designed to move, between a released position, and an engaged position. At the released position, the slider device is farther apart from a center of the rotor, while at engaged position, the slider device is closer to the center of the rotor. That is, at the engaged position, the plurality of the magnets of the rotor are in a proximate distance of magnets of the slider device.

In some embodiments, the rotor includes a hole in a center of the rotor. The hole is configured to attach the rotor to the fishing reel. In some embodiments, the magnets are cylindrical-shaped. The cylindrical magnets are so positioned that if a north pole end of a first magnet is facing the line spool, south ends of two adjacent magnets of the first magnet are facing the line spool, and vice versa. It is possible to change the magnetic force required for braking by changing the spacing between the magnets and/or increasing/decreasing the strength of one or more magnets. This can be accomplished by having magents of different sizes. For example, in some embodiments, a user may increase the space between one or more of the magnets when the required force for braking the fishing reel in a certain situation is less than the force produced between existing magnets at a current distance apart.

In some embodiments, the fishing reel is a fly reel. In some embodiments, the fishing reel is a centrepin reel. In some embodiments, the magnets have a same size. In some embodiments, magnets of different sizes can be used. In some embodiments, the rotor is made of a magnetically conductive material. In some embodiments, the rotor is made of a non-magnetic material.

### BRIEF DESCRIPTION OF THE DRAWINGS

FIG. 1A illustrate a magnetic braking system, in accordance with some embodiments.

FIG. 1B illustrate a magnetic braking system, in accordance with some embodiments.

FIG. 2 illustrate a magnetic braking system, in accordance with some embodiments.

FIG. 3 illustrate a magnetic braking system, in accordance with some embodiments.

FIG. 4A illustrate a magnetic braking system, in accordance with some embodiments.

FIG. 4B illustrate a magnetic braking system, in accordance with some embodiments.

In accordance with common practice some features illustrated in the drawings cannot be drawn to scale. Accordingly, the dimensions of some features can be arbitrarily expanded or reduced for clarity. In addition, some of the drawings cannot depict all of the components of a given system, method or device. Finally, like reference numerals can be used to denote like features throughout the specification and figures.

### DETAILED DESCRIPTION

It will also be understood that, although the terms first, second, etc. are, in some instances, used herein to describe various elements, these elements should not be limited by these terms. These terms are only used to distinguish one element from another. For example, a first device could be termed a second device, and, similarly, a second device could be termed a first device, without departing from the scope of the various described embodiments. The first device and the second device are both devicees, but they are not the same device, unless the context clearly indicates otherwise.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

It should be appreciated that in the development of any actual embodiment (as in any development project), numerous decisions must be made to achieve the developers' specific goals (e.g., compliance with system and business-related constraints), and that these goals will vary from one embodiment to another. It will also be appreciated that such development efforts might be complex and time consuming but would nevertheless be a routine undertaking for those of ordinary skill in the art of image capture having the benefit of this disclosure.

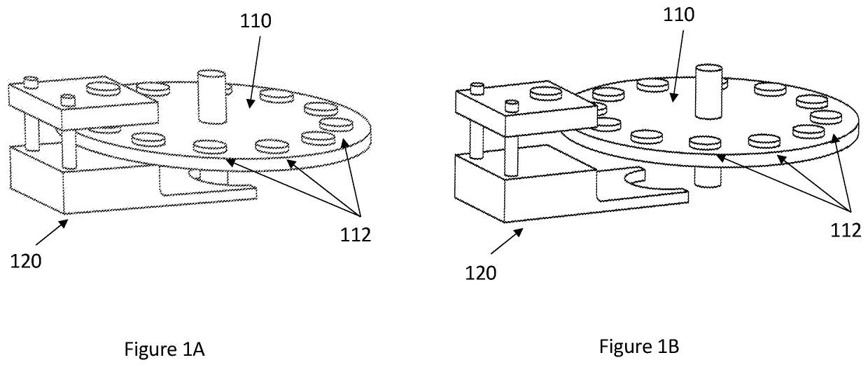

FIGS. 1A-4B illustrate a magnetic braking system, in accordance with some embodiments. Referring to FIG. 1A, in some embodiments, the magnetic braking system includes a rotor 110 and a slider device 120. The rotor 110 is attached to a bearing which is further attached to a fishing reel. The rotor 110 includes a plurality of spaced-apart holes, and a plurality of magnets 112. In some embodiments, each of the plurality of holes is located at a same distance from each other in a circular manner on the rotor 110. Each of the plurality of magnets 112 is located in a respective member of the plurality of holes. In some embodiments, a first end of each of the plurality of magnets is positioned in a common plane. The common plane is perpendicular to an axis of rotation of a spool. FIG. 1A illustrates the magnetic braking system when the rotor 110 and the slider device 120 are in a proximate distance from each other, i.e., at engaged position (discussed below). FIG. 1B illustrates the magnetic braking system when the rotor 110 and the slider device 120 are farther apart from each other, i.e., at released position (discussed below).

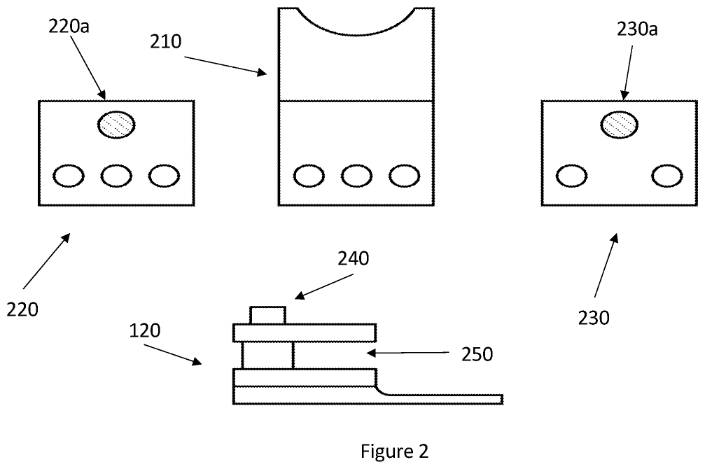

Referring to FIG. 2, the slider device 120 includes a three-layer structure stacked on each other: a first sheet 210, a second 1 sheet 220 and a third sheet 230. The first sheet 210 is substantially larger than the second sheet 220 and the third sheet 230. The second sheet 220 is over the first sheet 210. The second sheet 220 and the third sheet 230 are substantially a same size. The third sheet 230 is over the second sheet 220. Each of the second sheet 220 and the third sheet 230 includes a magnet 220a and 220a in a hole, similar to the rotor 110. The three-layer sheets of the slider device 120 are attached together using a cylinder 240. In some embodiments, the first sheet 210 and the second sheet 220 are in contact with each other. In some embodiments, the sheets 210, 220 and 230 and the cylinder are made of one of: a , an alloy, a polymer, or any other suitable materials.

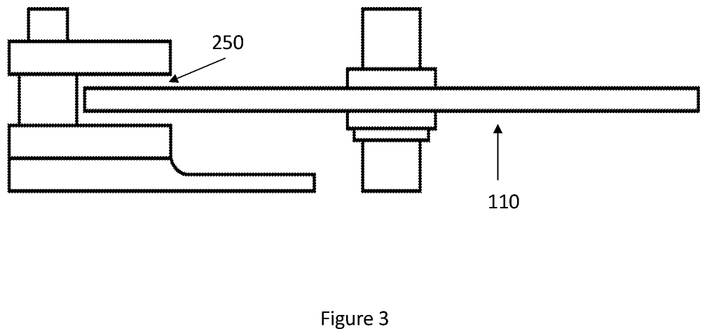

The second sheet 220 and the third sheet 230 are separate from each other, thus, creating a gap 250. The gap 250 is so designed that a size of the gap 250 is larger than a thickness of the rotor 110. This enables the rotor 110 to be located between the second sheet 220 and the third sheet 230 when braking, as illustrated in FIG. 3. When the rotor 110 is in the gap 250, the interactions between the plurality of magnets of the rotor 110 and the magnets of the second and the third sheet 220a and 230a cause the rotor 110 and subsequently the reel to stop from rotating. In other words, the magnetic force between the magnets of the rotor and the slider device stops the rotor from rotating when the slider device is pushed to engage with the rotor.

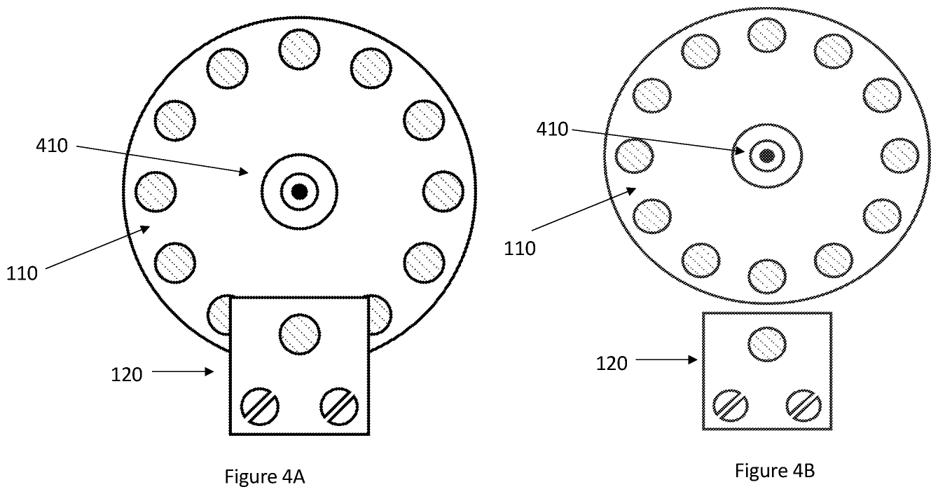

FIGS. 4A and 4B illustrate the magnetic braking system in accordance with some embodiments. The rotor 110 and the slider device 120 are configured to brake the fishing reel once they are engaged. To that end, the slider device 120 is so designed to move, i.e., slide, between a first position, i.e., a released position, and a second position, i.e., an engaged position. At the released position, the slider device 120 is farther apart from a center of the rotor 110, while at engaged position, the slider device 120 is closer to the center of the rotor 110. That is, at the engaged position, the plurality of the magnets of the rotor 110 are in a proximate distance of magnets of the slider device 120. FIG. 4A illustrates the magnetic braking system when the rotor 110 and the slider device 120 are in a proximate distance from each other, i.e., at the engaged position. FIG. 4B illustrates the magnetic braking system when the rotor 110 and the slider device 120 are farther apart from each other, i.e., at the released position.

In some embodiments, the sheets 210, 220 and 230 are attached to each other by bolts and nuts.

In some embodiments, the rotor 110 includes a hole 410 in a center of the rotor 110. The hole 410 is configured to attach the rotor 110 to the fishing reel.

In some embodiments, the magnets are cylindrical-shaped. The cylindrical magnets are so positioned that if a north pole end of a first magnet is facing the line spool, south ends of two adjacent magnets of the first magnet are facing the line spool, and vice versa. It is possible to change the magnetic force required for braking by changing the spacing between the magnets and/or increasing/decreasing the strength of one or more magnets. For example, in some embodiments, a user may increase the space between one or more of the magnets when the required force for braking the fishing reel in a certain situation is less than the force produced between existing magnets at a current distance apart.

In some embodiments, the fishing reel is a fly reel. In some embodiments, the fishing reel is a centrepin reel.

In some embodiments, the magnets have a same size. In some embodiments, magnets of different sizes can be used. In some embodiments, the rotor is made of a magnetically conductive material. In some embodiments, the rotor is made of a non-magnetic material.

Using disclosed magnetic braking system for fishing reels eliminates using clicker systems that are usually spring-loaded on with touching parts that can wear and make noise.

In some embodiments, the system for magnetic braking in fishing reels includes a fishing reel including a spool, a lever, a rotor, and a slider device. The rotor includes a plurality of spaced-apart holes located at substantially a same distance from each other in a circular manner on the rotor, and a plurality of magnets located in the plurality of holes. A first end of each of the plurality of magnets is positioned in a common plane perpendicular to an axis of rotation of the spool. The slider device includes a first sheet, a second sheet over the first sheet and a third sheet over the second sheet. Each of the second sheet and the third sheet include a magnet in a hole. The slider device is movable between a first position and a second position, where the first position is farther apart from a center of the rotor. There is a gap between the second sheet and the third sheet, where the gap is substantially larger than the thickness of the rotor. The slider device is movable between a first position and a second position, the first position is farther apart from a center of the rotor. The interactions between the one or more magnets of the movable slider device and the plurality of the magnets of the rotor cause the rotor to brake when the movable slider device is at the second position and the rotor is in the gap.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A system for magnetic braking in fishing reels, the system comprising:
a fishing reel, the fishing reel comprising a spool;
a lever;
a rotor, the rotor comprising:
a plurality of spaced-apart holes located at substantially a same distance from each other in a circular manner on the rotor, and
a plurality of magnets located in the plurality of holes, a first end of each of the plurality of magnets being positioned in a common plane, the common plane being perpendicular to an axis of rotation of the spool; and
a slider device, the slider device comprising:
a first sheet;
a second sheet over the first sheet, the second sheet comprising a magnet in a hole, and
a third sheet over the second sheet, the third sheet comprising a magnet in a hole,
wherein a gap is formed between the second sheet and the third sheet, the gap being substantially larger than the thickness of the rotor, wherein the slider device is movable between a first position and a second position, the first position being farther apart from a center of the rotor,
and wherein interactions between the one or more magnets of the slider device and the plurality of the magnets of the rotor cause the rotor to brake when the slider device is in the second position and the rotor is in the gap.

2. The system of claim 1, wherein the fishing reel is a fly reel.

3. The system of claim 1, wherein the fishing reel is a centrepin reel.

4. The system of claim 1, wherein the plurality of magnets has a same size.

5. The system of claim 1, wherein the rotor comprises a magnetically conductive material.

6. The system of claim 1, wherein the rotor comprises a hole in a center of the rotor, and wherein the hole is configured to attach the rotor to the fishing reel.

7. The system of claim 1, wherein the first sheet is substantially larger than the second sheet and the third sheet.

8. The system of claim 1, wherein the second sheet and the third sheet are substantially a same size.

9. The system of claim 1, wherein at least one of the: the first sheet, the second sheet, and the third sheet include at least one of: metal, an alloy, a polymer, and a hardened material.
